(19) United States
(12) Patent Application Publication
(10) Pub. No.: US 2002/0175145 A1
(43) Pub. Date: Nov. 28, 2002

(54) Method of forming void-free intermetal dielectrics

(76) Inventors: Shyh-Dar Lee, Hsinchu Hsien (TW); Ping-Wei Lin, Hsinchu (TW); Ming-Kuan Kao, Hsinchu (TW)

Correspondence Address: BIRCH STEWART KOLASCH & BIRCH, PO BOX 747, FALLS CHURCH, VA, 22040-0747, US

(21) Appl. No.: 09/864,371

(22) Filed: May 25, 2001

(51) Int. Cl. C23F 1/00; B44C 1/22; C03C 15/00

(52) U.S. Cl. 216/67

(57) ABSTRACT

An HDPCVD oxide layer is deposited over metal lines on a semiconductor substrate. The HDPCVD oxide layer so deposited has ridged portions over the metal lines. The HDPCVD oxide layer is then treated in-situ with an inert gas or reactive gas plasma to remove the ridged portions on the surface. A sacrificial dielectric layer can then be deposited on the HDPCVD oxide layer with good step coverage, thereby to eliminate voids.

### BACKGROUND OF THE INVENTION

1. Field of the Invention

The present invention relates in general to the formation of a dielectric material for integrated circuit manufacturing. In particular, this invention relates to a process for forming a void-free intermetal dielectric using high density plasma chemical vapor deposition (HDPCVD).

2. Description of the Related Arts

Metal interconnect structures are an important part of ULSI integrated circuits. The metal interconnect structures typically include metal lines and vias. The vias are used to interconnect the metal lines with conductive structures above and below the metal interconnect layer. Sophisticated ICs may include several layers of metal interconnect structures. The metal lines are commonly used on ULSI integrated circuits for carrying digital signals, analog signals, or bias power to and from the embedded semiconductor devices.

Typically, after the metal lines have been formed through metal etching, a dielectric layer is deposited over the metal lines for insulation purposes. This dielectric layer is referred to as either an intermetal dielectric (IMD), or an interlayer dielectric (ILD). The insulating dielectric layer typically is formed from a composite of multiple layers of oxide. For example, in many processes, the insulative dielectric layer comprises a bulk oxide layer followed by a cap oxide layer.

As integration density increases, the aspect ratio of the gaps between adjacent metal lines also increases. It has been found that conventional chemical vapor deposition of oxides oftentimes fails to exhibit acceptable gap filling characteristics, and results in imperfections and discontinuities, such as keyholes and incomplete filling while filling the gaps.

One type of oxide that has been demonstrated as having encouraging gap filling capabilities is the high density plasma chemical vapor deposition (HDPCVD) oxide. HDPCVD oxide technology has only been developed in the past few years. Thus, although HDPCVD oxide remains a promising gap filling alternative for high aspect ratio gaps, difficulties have been found in the practical application of the HDPCVD oxide technology.

FIGS. 1-2 shows a process for forming an interlmetal dielectric over metal lines according to the prior art process. In FIG. 1, metal lines 102 are formed on a substrate 100. The substrate 100 includes a semiconductive wafer, active and passive devices formed within the wafer, and layers formed on the wafer surface. In other words, substrate includes devices formed within a semiconductor wafer and the layers overlying the wafer.

The metal lines 102 are typically formed from either copper or aluminum. Beneath the metal line 102, there is a surface layer 101 which may comprise a material such as titanium nitride, titanium-silicide, or a titanium-tungsten alloy. The surface layer 101 acts as a barrier to prevent interactions between the silicon and the aluminum, such as interdiffustion. On the metal line 102, there is a protective layer 103 such as a titanium nitride layer. As is known by those of ordinary skill in the art, the protective layer 103 serves several functions. For instance, the protective layer 103 may act as an anti-reflection coating (ARC) during the process of patterning the metal lines 102.

A gap filling HDPCVD oxide 104 is deposited over the protective layer 103 and the metal lines 102. The mechanism by which the HDPCVD oxide is formed is by a combination of deposition and sputtering (also known as “sputter-etch” or simply “etch” in the art). Those portions of a deposited layer that are closest to a gap are the most likely to be etched and sputtered into the gap. This produces sharp ridges (triangular shape in cross section) over metal lines 102, which is a recognized characteristic of the HDPCVD process, along with the ability of the process to fill gaps effectively.

However, this approach has shown limited success in preventing the occurrence of voids. Referring to FIG. 2, experiments have indicated that the faceted topography of the HDPCVD oxide gives rise to gaping voids 106 when a later sacrificial oxide layer 105 is deposited. This phenomena is due to poor step coverage of the sacrificial oxide deposition on the sharp ridges of the HDPCVD oxide 104 over the metal lines 102. These voids 106 tend to weaken the integrity of the intermetal dielectric structure. In addition, subsequent planarization processes may uncover the voids 106 and materials such as polishing chemicals or polymerized etch byproducts may become trapped in the voids. Material trapped in the voids may be difficult to remove. Subsequent processing steps then exhibit reduced yields due to contamination from the materials trapped in the voids.

It has been contemplated to solve the above problems by increasing the HDPCVD oxide thickness. As the HDPCVD oxide grows in thickness, the HDPCVD layer tends to self-planarize and the ridges gradually disappear. Unfortunately, HDPCVD process has a very low deposition rate and is high-cost. In other words, this approach will severely sacrifice the throughput and increase the process cost.

The present invention is directed towards a method of forming intermetal dielectrics in such a manner so as to eliminate the problems of the prior art without sacrificing the throughput and increasing the process cost.

### SUMMARY OF THE INVENTION

It is therefore an object of the invention to provide a method of forming void-free intermetal dielectrics that provides improved reliability.

It is another object of the invention to provide a method of forming void-free intermetal dielectrics without sacrificing the throughput.

It is a further object of the invention to provide a method of forming void-free intermetal dielectrics without substantially increasing the process cost.

To obtain the above and other objects, a plasma treatment is performed, preferably in-situ, after HDPCVD deposition, thereby removing the sharp ridges of the HDPCVD oxide. Therefore, good step coverage can be achieved when a later sacrificial layer is deposited. In addition, the present method does not require the HDPCVD oxide to completely fill the gaps between adjacent metal lines. Thus, the deposition time of HDPCVD can be further decreased to improve the throughput.

The method according to the invention includes the following steps. First, form a high density plasma chemical vapor deposition (HDPCVD) oxide layer to cover the metal lines, the HDPCVD oxide layer having ridged portions over the metal lines. Then, expose the HDPCVD oxide layer to a plasma treatment, thereby removing the ridged portions of the HDPCVD oxide layer. Finally, form a dielectric layer over the HDPCVD oxide layer.

Other objects, features, and advantages of the present invention will become apparent from the following detailed description which makes reference to the accompanying drawings.

### BRIEF DESCRIPTION OF THE DRAWINGS

FIGS. 1-2 are cross-sectional views illustrating the steps of a conventional method for fabricating IMD; and

FIGS. 3-9 are cross-sectional views illustrating the steps for fabricating void-free IMD according to a preferred embodiment of the invention.

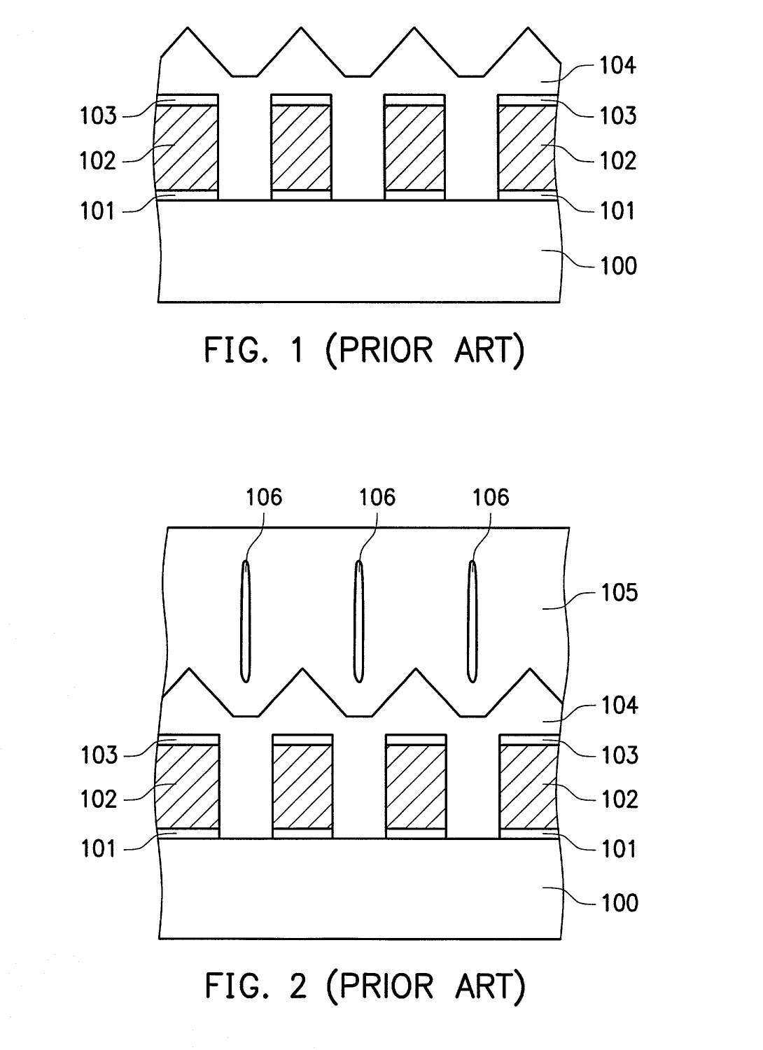

### DESCRIPTION OF THE PREFERRED EMBODIMENTS

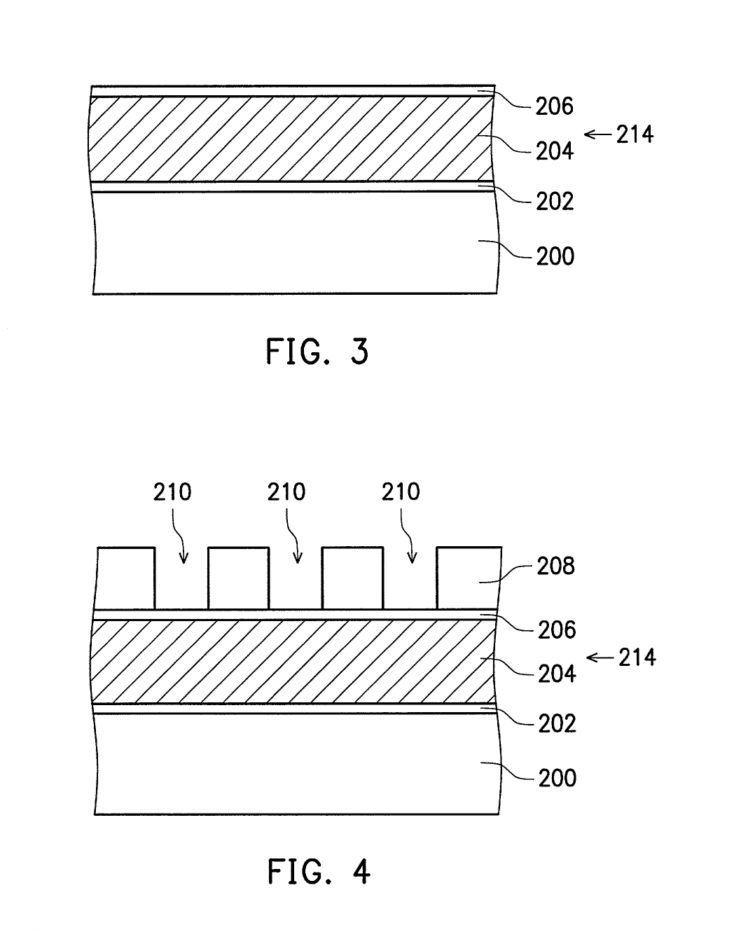

Preferred embodiments of the present invention are now described with reference to FIGS. 3-9. FIG. 3 shows a cross-sectional view of a semiconductor substrate 200 having a number of layers deposited thereon for the formation of wiring lines. The substrate may contain a variety of devices, including, for example, transistors, diodes, and other semiconductor devices (not shown) as those well-known in the art. The substrate 200 may also contain other metal interconnect layers.

As seen in FIG. 3, a surface layer 202 is deposited on the substrate, followed by a wiring line layer 204. If portions of the surface of the substrate 200 which will make contact with the wiring lines are silicon and the wiring line layer 204 is aluminum, then the surface layer 202 may comprise a material selected from titanium nitride, titanium-silicide, or a titanium-tungsten alloy. The surface layer 202 acts as a barrier to prevent interactions between the silicon and the aluminum, such as interdiffusion. The surface layer 202 may also help adhere the wiring line layer 204 to the substrate 200, particularly when the wiring lines are formed on a dielectric layer, and may reduce electromigration tendencies in the aluminum wiring lines. The wiring line layer 204 may be formed from a variety of materials, such as aluminum, copper, aluminum alloyed with silicon/copper, alloys including copper, and multilayer structures including relatively inexpensive metals and relatively expensive metals, such as the refractory metals. A protective layer 206 is deposited above the wiring line layer 204. The protective layer 206 may be formed by the same material as the surface layer 202. The protective layer 206 serves several functions, including the protection of the wiring line layer 204 during the patterning process, limiting electromigration for providing more reproducible contacts, and acting as an antireflective coating above the wiring line layer 204. Titanium nitride is a particularly preferred material for the protective layer 206. The thickness of the protective layer 206 is typically on the order of one to a few hundred angstroms.

Referring to FIG. 4, a layer of photoresist is provided and shaped over the protective layer 206 to form an etching mask 208. The regions 210 exposed on the surface of the protective layer 206 are then etched to form trenches thereby defining the wiring lines.

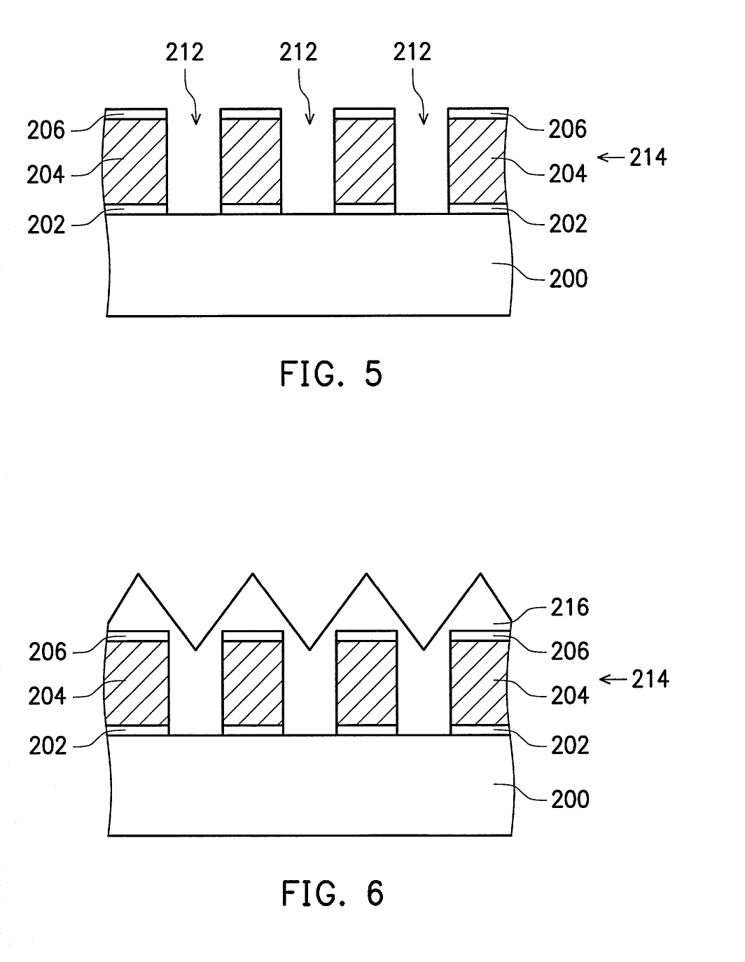

Referring to FIG. 5, the wiring lines are formed by consecutively etching layers 206, 204 and 202 from the surface of the substrate 200 in order to form gaps 212 between the wiring lines. A small portion of the substrate 200 may be etched as well. The etch processes used to remove these layers are preferable highly anisotropic. They may, for example, be performed by reactive ion etching (RIE). A suitable etchant for the protective layer 206, metal line layer 204 and surface layer 202 may be derived from a mixture of gases that includes HCl, Cl₂, or Cl₂ and BCl₃.

After the etching process is completed and the etching mask 208 is removed, the structure includes gaps 212 located between individual wiring lines 214. An HDPCVD step is then carried out to form layer 216. The HDPCVD of layer 216 is performed until the gap 212 is completely or partially filled with HDPCVD oxide. As shown in FIG. 6, the HDPCVD technique is observed to produce sharp ridges (triangular shapes in cross section) on the portions over wiring lines 214.

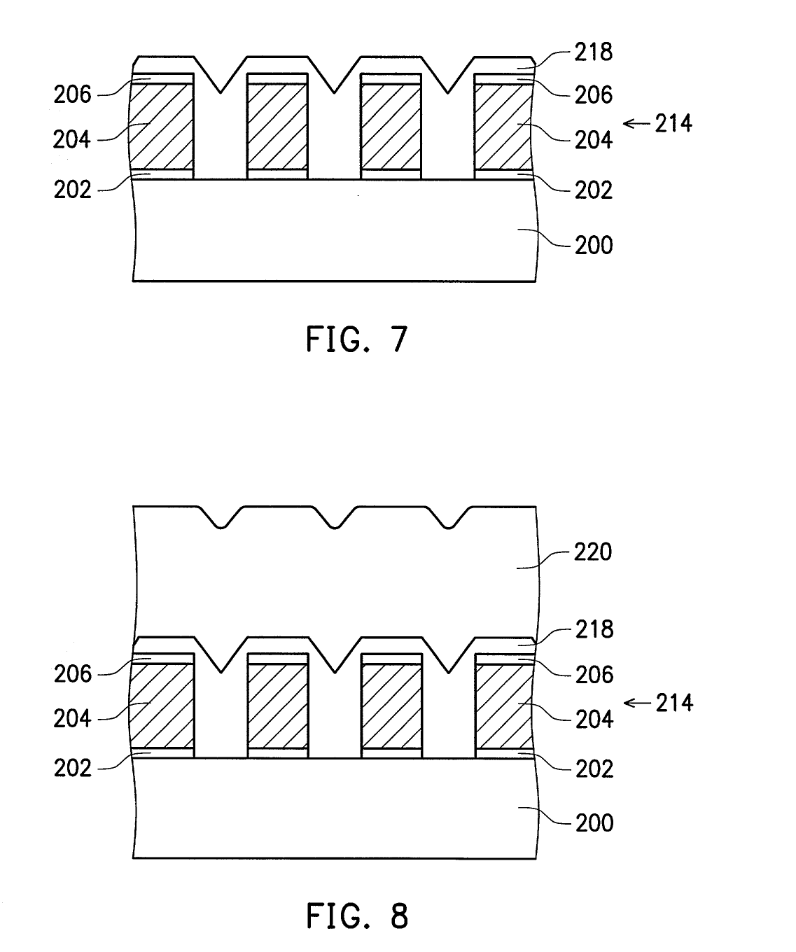

The HDPCVD oxide layer 216 is then treated with the novel in-situ plasma treatment to remove any ridged portions on the HDPCVD layer 216 surface. The plasma treatment can use several inert gases such as Ar, He, and N₂. Alternatively, this plasma treatment can use several reactive gases such as O₂, N₂O, etc. The plasma treatment process is preferably in-situ in the same HDPCVD reactor. FIG. 7 shows that the HDPCVD oxide layer 218 has a smoother topography after the plasma treatment. Specifically, the HDPCVD oxide layer 218 may have trapezoidal shapes over the metal lines in a cross-sectional view.

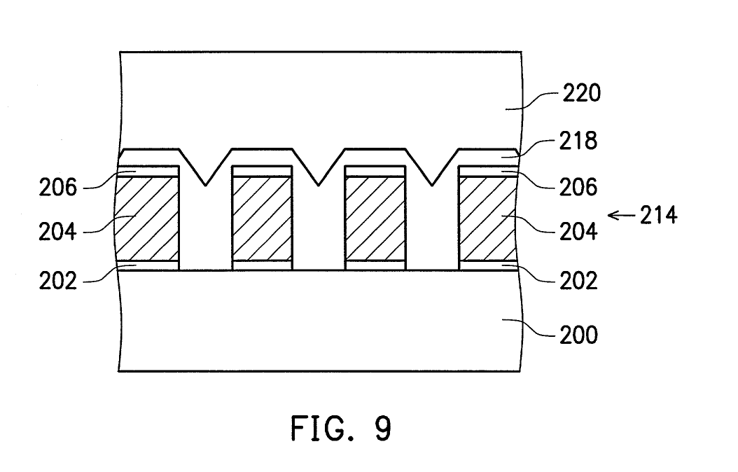

Referring to FIG. 8, a sacrificial dielectric layer 220 is formed over the HDPCVD oxide layer 218. The dielectric layer 220 may be selected from a variety of materials and formed using a variety of techniques. Preferably, the dielectric layer 220 is a plasma-enhanced chemical vapor deposition (PECVD) oxide layer or a spin-on-glass (SOG) layer. The dielectric layer 220 is deposited with good step coverage and free of voids because of the smoother topography of the underlying layer. The dielectric layer 220 is then planarized by, for example, a chemical mechanical polishing (CMP) process, to complete an intermetal dielectric structure as shown in FIG. 9.

Thus, by removing the ridged portions of HDPCVD oxide by inert gas plasma treatment, a void-free overlying layer 220 can be deposited as a part of IMD structure. Problems due to impurities trapped in the voids will be minimized. Further, because the plasma treatment is performed in-situ, this process does not sacrifice the throughput and the cost is relatively low as compared to an HDPCVD process.

In another aspect of the present invention, the throughput can be further improved by reducing the deposition time of the HDPCVD oxide 216. Referring back to FIG. 6, in the conventional approach of the HDPCVD gap filling, the HDPCVD of the oxide layer 216 is performed until the gap 212 is completely filled with high density oxide. Sometimes the HDPCVD is continued even when the gap is filled to obtain a self-planarized surface because the HDPCVD layer tends to be self-planarized as the deposition proceeds. On the other hand, as the ridged portions of the HDPCVD oxide 216 will ultimately be smoothened by the plasma treatment, there is no need for the present invention to deposit unnecessary thickness for a self-planarized surface. In most cases, it is not necessary for the gap 212 to be filled up to top of the protective layer 206. Instead, the HDPCVD of oxide layer 216 can be stopped while about 75-85% of the gap 212 is filled to further improve the throughput.

While the invention has been particularly shown and described with reference to the preferred embodiment thereof, it will be understood by those skilled in the art that various changes in form and details may be made without departing from the spirit and scope of the invention.

What is claimed is:

1. A method of forming an intermetal dielectric layer over metal lines on a semiconductor substrate, comprising the steps of:
forming a high density plasma chemical vapor deposition (HDPCVD) oxide layer to cover said metal lines, said HDPCVD oxide layer having ridged portions above said metal lines;
removing said ridged portions of said HDPCVD oxide layer by exposing said HDPCVD oxide layer to a plasma treatment; and
forming a dielectric layer over said HDPCVD oxide layer.

2. The method as claimed in claim 1, wherein said metal lines are separated by gaps, and said HDPCVD oxide layer completely fills said gaps.

3. The method as claimed in claim 1, wherein said metal lines are separated by gaps, and said HDPCVD oxide layer partially fills said gaps.

4. The method as claimed in claim 1, wherein said plasma treatment uses an inert gas plasma.

5. The method as claimed in claim 4, wherein said inert gas plasma is selected from the group consisting of Ar, He, and N₂.

6. The method as claimed in claim 1, wherein said plasma treatment uses a reactive gas plasma.

7. The method as claimed in claim 6, wherein said reactive gas plasma is selected from the group consisting of O₂ and N₂O.

8. The method as claimed in claim 1, wherein said step of exposing the HDPCVD oxide layer to a plasma is performed in-situ while forming the HDPCVD oxide layer.

9. The method as claimed in claim 1, wherein said ridged portions of said HDPCVD oxide layer have triangular shapes in a cross-sectional view.

10. The method as claimed in claim 1, wherein said HDPCVD oxide layer has trapezoidal shapes in a cross-sectional view over said metal lines after exposing to said plasma treatment.

11. The method as claimed in claim 1, wherein said dielectric layer is formed by an oxide material.

12. A method of forming an intermetal dielectric layer over metal lines on a semiconductor substrate, said metal lines are separated by gaps, said method comprising the steps of:
forming an HDPCVD oxide layer to cover said metal lines, said HDPCVD oxide layer partially filling said gaps and having ridged portions over said metal lines;
removing said ridged portions of said HDPCVD oxide layer by exposing said HDPCVD oxide layer to a plasma treatment;
forming a dielectric layer over said HDPCVD oxide layer; and
planarizing said dielectric layer.

13. The method as claimed in claim 12, wherein said step of exposing the HDPCVD oxide layer to a plasma treatment is performed in-situ while forming the HDPCVD oxide layer.

14. The method as claimed in claim 12, wherein said ridged portions of said HDPCVD oxide layer have triangular shapes in a cross-sectional view.

15. The method as claimed in claim 12, wherein said HDPCVD oxide layer has trapezoidal shapes in a cross-sectional view over said metal lines after exposing to said plasma treatment.

16. The method as claimed in claim 12, wherein said dielectric layer comprises a spin-on-glass (SOG) layer.

17. The method as claimed in claim 12, wherein said dielectric layer comprises a plasma-enhanced chemical vapor deposition (PECVD) oxide layer.

18. The method as claimed in claim 12, wherein said dielectric layer is planarized using a chemical mechanical polishing (CMP) process.

19. The method as claimed in claim 12, wherein said plasma treatment uses an inert gas plasma selected from the group consisting of Ar, He, and N₂.

20. The method as claimed in claim 12, wherein said plasma treatment uses a reactive gas plasma selected from the group consisting of O₂ and N₂O.
